(19) United States
(12) Patent Application Publication
(10) Pub. No.: US 2008/0186952 A1
(43) Pub. Date: Aug. 7, 2008

(54) Method and system for setting up a multimedia session in multimedia internetworking systems

(75) Inventors: Ming Lin, Shenzhen (CN); Fang Yin, Shenzhen (CN)

Correspondence Address: Akin Gump Strauss Hauer & Feld LLP, P. O. Box 688, Dallas, TX, 75313-0688, US

(73) Assignee: Huawei Technologies Co., Ltd.

(21) Appl. No.: 11/591,723

(22) Filed: Nov. 1, 2006

Related U.S. Application Data
(60) Provisional application No. 60/837,379, filed on Aug. 11, 2006.

(51) Int. Cl. H04L 12/66

(52) U.S. Cl. 370/352

(57) ABSTRACT

This invention discloses a method and system for preparing for setting up a multimedia session between two terminals in a multimedia internetworking system, the method comprises receiving a call setup message by the gateway controller module from a first terminal for setting up the multimedia session with a second terminal, exchanging at least one call reference between the gateway controller module and gateway module based on the call setup message for identifying the multimedia session, exchanging one or more session setup messages through a communication tunnel between the gateway module and gateway controller module for allocating resources for the multimedia session with the call reference including a predetermined location within the session setup messages for containing session information, and initiating the multimedia session between the first and second terminals with the allocated resources.

### BACKGROUND

The present invention relates generally to multimedia internetworking and, more particularly, to reducing the network resource requirement for multimedia communications.

Public Switched Telephone Network (PSTN) is a circuit-switching network, which traditionally provides telephone services. Since PSTN is not designed to carry high-speed digital data, using PSTN for digital data services has several drawbacks. For example, the data rate is lower and the latency is longer. PSTN incurs more costs and it is not easy to provide new services to the customers. With the advances of telecommunications equipment and the exponential demands for digital data services, the trend in the telecommunications industry is to create a new type of telecommunications network that is designed to serve both voice services and digital data services.

A Next Generation Network (NGN) is one of the products of the latest development in the telecommunications industry. The NGN uses a Softswitch technology and has evolved rapidly in recent years. The NGN unites Asynchronous Transfer Mode (ATM) technology with Internet protocol (IP), and is capable of providing not only the traditional PSTN services but also video and digital data services. The Softswitch technology is a software-based switching solution that separates the call control from the bearer control and transmission resource functions.

In a traditional circuit-switched network, hardware and software are tightly bound together. The traditional circuit-switched network relies on dedicated facilities for interconnection and is designed primarily for voice communication. However, with the Softswitch, a telecommunication network can manage more workload, provide more voice services, and generate more businesses.

The NGN network uses Media Gateway Control Protocol (MGCP) and/or H.248 protocol to achieve the separation of a call control function from the network operation for the multimedia session. MGCP protocol was first developed to convert the audio signals carried in telephone circuits (PSTN) to data packets carried over the Internet or other packet networks. MGCP is no longer under development because it has been replaced by the second-generation call control protocol H.248.

Developed from MGCP, H.248 protocol is a new generation of gateway control protocol that supports the creation, modification and release of communication channels. Its open architecture plays an important role in assuring the interoperability of different types of networks.

Specifically, H.248 protocol addresses the relationship between a gateway module and a gateway controller module. The gateway module converts circuit-switched voice to packet-based traffic. The gateway controller module controls call setup functions.

In one of the embodiments, the NGN, the gateway module is a Media Gateway (MGW) and the gateway controller module is a Media Gateway Controller (MGC). In another embodiment, the WCDMA mobile network, the gateway module is MGW and the gateway controller module is a Mobile Switching Center (MSC) server. In yet another embodiment, the IMS network, the gateway module includes an IP Multimedia Media Gateway (IM-MGW) and a Multimedia Resource Function Processor (MRFP). The gateway controller module in the IMS network includes a Media Gateway Control Function (MGCF) and a Media Resource Function Controller (MRFC).

For clarity of this document, we use “MGW” and “MGC” to demonstrate our invention. In other words, the term “MGW” is the gateway module, which is a synonym of IM-MGW and MRFP while the term “MGC” is the gateway controller module, which is a synonym of the MSC server, MGCF, and MRFC.

Terminations and contexts are two basic components of H.248. A termination is a logical entity on a MGW that sources and/or sinks media and/or control streams. A context is an association among a collection of the terminations. A context is created and released by a MGW under the command of an MGC. It is created by adding the first termination and is released by removing (subtracting) the last termination. ITU-T specification H.248.1 “Gateway control protocol” defines the protocol.

An H.248 package defines attributes, which includes properties, events, signals, and statistics to manage the resource of the termination in order to service a call. Different gateways may have different attributes. When a MGW supports a package, it supports all the attributes associated with this package. By defining packages, the H.248 can adapt to a wide range of applications without needing to change the definition of the protocol itself.

A H.248 protocol suite includes a series of annexes, from H.248.1 to H.248.45, most of which define H.248 packages. With the development of new services, the number of annexes is increasing. In particular, H.248.12, titled “H248.1 packages for H.323 and H.324 internetworking,” defines five types of packages: h324, h245, h323bc, h245com, and h245ind. They are used to implement the multimedia communication between H.324 terminal and H.323 terminal. They can also be used to implement the multimedia communication between H.324 terminal and Session Initiation Protocol (SIP) terminal.

The communication between H324P/H324M/H324I terminals of wired-line and mobile networks is based on the H.324 protocol suite, which includes H.324, H245, H223, etc. The communication between H.323 terminals of a wired-line network is based on the H.323 protocol suite, which includes H.323, H.225.0, H.245, RTP, RTCP, etc. Similarly, the communication between SIP terminals of a wired-line network/IMS network is based on the SIP protocol suite, which includes SIP, SDP, RTP, RTCP and etc.

In order to support multimedia internetworking between H.324 and H.323 terminals, the network must have a protocol conversion entity that bridges call control signalling and multimedia data between them. Conversion is done by a Video Internetworking Gateway (VIG). The VIG could be either a stand-alone MGW or a VIG function that is embedded in a MGW. An embedded VIG costs less than a stand-alone MGW, and requires no additional network equipment. In addition, since a VIG function is embedded in a MG, the data routing cost for a call setup process is greatly reduced, which enhances the quality of the communication channel. An embedded VIG function follows the H248.12 standard.

H.248.12 specifies two models that support multimedia internetworking between H.323 and H.324 terminals with physically separate Media Gateways. In the first model, a MGW terminates H.245 call control signalling messages. H.245 call control signalling messages issued from either H.324 or H.323 terminals are processed within the MGW. The MGW also manages the resources of the logical communication channel. However, in the second model, it is the MGC that terminates the H.245 call control signalling messages. The MGC manages and controls H.323 and H.324 terminals while the MGW is responsible for the media conversion function. The call setup process of the second model is described below.

In order to establish multimedia internetworking between H.324MS (Mobile Station) terminal and H323/SIP terminal, the following four terminations must be set up in the multimedia internetworking gateway: termination T1, termination MUX, audio termination Ra, and video termination Rb. The functions of these terminations are described in connection models of H.248.20.

In an H.324MS terminal and H.323/SIP terminal internetworking system with the MGC being responsible for terminating H.245 call setup signalling messages, the exchange of H.245 signalling messages between a MGW and a MGC can be carried over the connection-oriented reliable protocol such as SCTP or TCP. It can also be carried over the unreliable connection-less protocol such as UDP. If the communication channel is based on the unreliable connection-less protocol, the upper layer must provide a reliable delivering mechanism such as re-transmission, and At-Most-Once functionality, as defined in H.248, for the reliable delivering of the H.245 signalling messages.

In the H.248.12 specification, a MGW is the conduit for an H.245 signalling message exchanged between H.324MS terminal and a MGC. The H.324MS terminal multiplexes H.245 signalling message into H.223 data streams. The MGW de-multiplexes H.245 signalling message from the multimedia data streams before forwarding them to the MGC for processing. In the reverse direction, the MGC sends a H.245 signalling message to the MGW and the MGW multiplexes the H.245 signalling messages into the H.223 data streams before forwarding them to the H.324MS terminal.

H.248.12 does not specifically define how an H.245 signalling message is exchanged between a MGW and a MGC. It simply states that a MGW and a MGC should reliably exchange H.245 signalling messages between each other. One reliable way to exchange an H.245 signalling message between a MGW and a MGC is to use Stream Control Transmission Protocol (SCTP) protocol (IETF RFC 2960) as the transport layer and consistently extend an SCTP tunnel to H.324MS terminal. However, H.248.12 does not define an interface to encapsulate the H.245 signalling messages in an SCTP tunnel.

According to the H.248.12 specification, there must be an SCTP tunnel that extends all the way to the H.324MS terminal. Based on this definition, a MGW must forward H.245 signalling messages received from the H.324MS terminal to a MGC via an SCTP tunnel and vice versa. In other words, every H.324 terminal must create an SCTP tunnel in order to send and receive H.245 signalling messages.

Setting up an SCTP tunnel for every call setup process is not realistic. Establishing and releasing an SCTP tunnel takes time. If an SCTP tunnel needs to be set up for every H.324 terminal, the setup and teardown process will take too long and as a result, the call setup timing requirement will not be met. Moreover, setting up an SCTP tunnel consumes a lot of resources. Under the condition of a high network load, a MGW and a MGC simply can not satisfy every demand for network resources.

Therefore what is desired is a method for linking a call setup message with its corresponding terminal, therefore, the call setup message can be transmitted between a MGW and a MGC without requiring dedicated channels.

### SUMMARY

This invention discloses a method and system for preparing for setting up a multimedia session between two terminals in a multimedia internetworking system.

According to one embodiment of the invention, the method comprises of receiving a call setup message by the gateway controller module from a first terminal for setting up a multimedia session with a second terminal, exchanging at least one call reference between the gateway controller module and gateway module based on the call setup message for identifying the multimedia session, and exchanging one or more session setup messages through a communication tunnel between the gateway module and gateway controller module for allocating resources for the multimedia session.

The call reference includes a first predetermined location within the session setup messages initiated by the gateway module and a second predetermined location within the resource allocation messages initiated by the gateway controller module. The multimedia session between the first and second terminal is initiated with the allocated resources.

According to another embodiment of the invention, another method comprises of receiving a call setup message by the gateway controller module from a first terminal for setting up a multimedia session with a second terminal, instructing the gateway module for notifying the gateway controller module for a first predetermined type of one or more resource allocation messages destined for the gateway controller module for the multimedia session, exchanging the resource allocation messages between the gateway controller module and the gateway module by embedding the resource allocation messages of the first predetermined type in a resource allocation message of a second predetermined type through a communication tunnel between the gateway module and gateway controller module for allocating resources for the multimedia session. The multimedia session between the first and second terminal is initiated with the allocated resources.

The present invention will be better appreciated and understood when considered in conjunction with the following description and the accompanying diagrams. It should be understood, however, that the following description, while indicating various embodiments of the invention and numerous specific details thereof, is given by way of illustrations. Additions and/or rearrangements may be made within the scope of the invention without departing from the spirit thereof, and the invention includes all such substitutions, modifications, additions and/or rearrangements.

### BRIEF DESCRIPTION OF THE DRAWING

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein. It should be noted that the features illustrated in the drawings are not necessarily drawn to scale.

FIG. 1 illustrates an H.248.1 connection model described in H.248.20.

FIG. 2 illustrates another H.248.1 connection model described in H.248.20.

FIG. 3 illustrates a conventional call setup process between an H.324MS terminal and a SIP terminal.

FIG. 4 is an example of an H.245 signalling message with a Call Reference message according to an embodiment of the present invention.

FIG. 5 illustrates a call setup process between an H.324MS terminal and a SIP terminal according to one embodiment of the present invention.

FIG. 6 shows interactions between a Media Gateway Controller (MGC) and a Media Gateway (MGW) when they are exchanging H.245 signalling messages with an H.248 tunnel.

FIG. 7 illustrates another call setup process using the H.248 tunnel to exchange H.245 signalling messages between the MGW and the MGC according to another embodiment of the present invention.

FIG. 8 illustrates one H.245 signalling message, the TCS (terminal capability set), maps to the call setup process with the H.248 commands exchanged between the H.324 MS, MGW and MGC.

### DESCRIPTION

The present invention discloses a method for associating a call setup message to its corresponding call instance and terminations in a multimedia internetworking gateway system through adding a call reference message in the call setup message, which is transmitted between a gateway controller module (MGW) and a gateway controller module (MGC) throughout a call setup process. Therefore, the call instance and terminations can be identified during a call setup process without using a dedicated channel to transmit the call setup message.

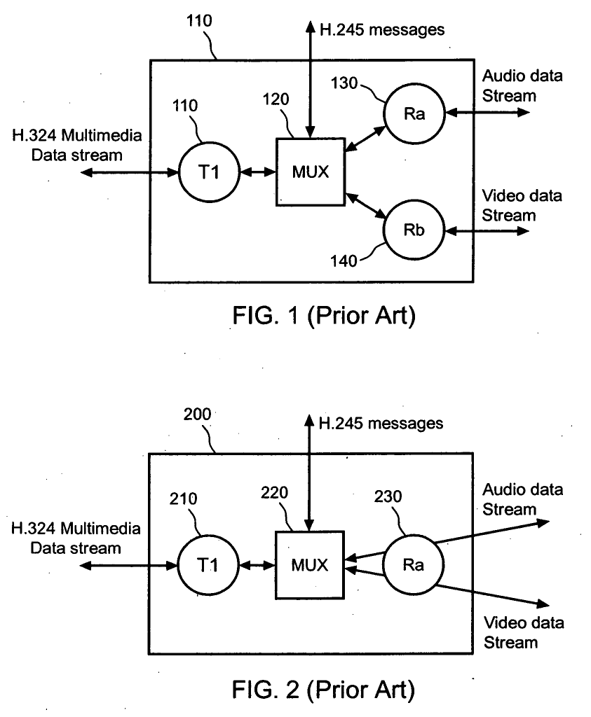

FIG. 1 illustrates an H.248.1 connection model 100 described in H.248.20. The termination T1 110 exchanges multimedia data streams between H.324MS mobile terminal and termination MUX 120. A multimedia data stream contains audio data, video data, and H.245 call control signalling messages.

The termination MUX 120 de-multiplexes H.245 multimedia data streams, coming from termination T1 110, into audio data, video data, and/or H.245 call control signalling messages. MUX 120 sends H.245 call control signalling messages to a MGC and forwards audio and video streams to audio termination Ra 130 or video termination Rb 140. In a reverse direction, the termination MUX 120 multiplexes audio data streams from Ra 130, video data streams from Rb 140, and H.245 call control signalling messages from the MGC into H.324 multimedia data streams and forwards them to termination T1 110.

FIG. 2 illustrates another H.248.1 connection model 200 described in H.248.20. One single termination Rc 230 relays audio and video data streams between termination MUX 220 and H.323/SIP termination.

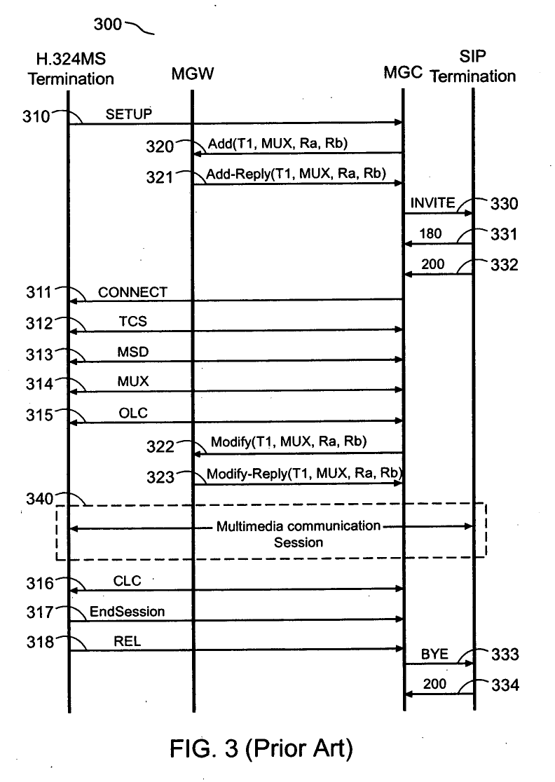

FIG. 3 illustrates a conventional call setup process 300 between an H.324 MS mobile terminal and a SIP terminal. The steps may be implemented as executable codes stored on a tangible medium, for example, a disk drive, a compact disc, or a transmission line medium. The method begins by a 3G mobile terminal (H.324MS) initiating a “call setup” process for a multimedia call through sending a SETUP message to an MGC (i.e., MSC server) in step 310. Based on the information in the SETUP message, the MGC acknowledges that the call is a multimedia call and the recipient of the call is an SIP terminal in the wired-line network. Using the standard H.248 protocol Add command, the MGC requests the MGW to allocate resources to four terminations: T1, MUX, audio Ra and video Rb in step 320. The Add command carries the call setup parameters for all four terminations. Using the H.248 Add-Reply command, the MGW returns the resources that are allocated to T1, MUX, audio and video terminations for this call to the MGC in step 321. The MGC sends an SIP INVITE message to the SIP terminal in step 330. The message carries the Session Description Protocol (SDP) attributes for audio and video data streams. The INVITE message also carries the information about the resources, allocated for this call, to the SIP terminal. In step 331, the SIP terminal obtains the information about the resources allocated for this call and returns the ring signal 180. In step 332, the SIP terminal returns the answer signal 200 to the MGC. In step 311, the MGC sends a CONNECT message back to the H.324MS terminal, which informs the H.324MS terminal that the call has been answered and the call setup initiation is completed.

Then the H.324MS terminal exchanges the following messages with the MGC: an H.245 call control signalling message, Terminal Capability Set (TCS) in step 312, an H.245 call control signalling message, master/slave determination (MSD) in step 313, an H.245 call control signalling message, Multiplex Entry Send (MUX), in step 314 and an H.245 call control signalling message, Open Local Channel (OLC), in step 315.

The H.324MS terminal and the MGC complete the negotiation of the network resources of this call. A logical communication channel for the exchange of a multimedia data stream is opened. The MGC learns about the audio and video CODEC used in the H.324M multimedia data stream, according to the information carried in the OLC message. In addition, it learns about the H.223 multiplex rule for audio, video, and H.245 call control signalling messages, based on the information carried in the MUX message.

In step 322, the MGC sends an H.248 command Modify to the MGW. The command includes information about the multiplex table, audio, and video CODEC for this multimedia call. In step 323, the MGW executes the command Modify and returns the outcome of the execution by sending a Modify-reply command back to the MGC. The call setup process is completed.

In step 340, the multimedia communication channel between the H.324MS terminal and SIP terminal is opened and both parties communicate with each other. The operation of multimedia communication between the H.324MS terminal and SIP terminal is performed as followings: Termination MUX in the MGW de-multiplexes the H.324M multimedia stream, coming from the H.324MS terminal, into audio and video data streams according to the H.223 multiplex rule. Audio termination Ra and video terminations Rb process the corresponding audio and video data streams according to the CODEC specified in the Modify command and relay the audio and video data streams to the SIP terminal. In the reverse direction, the audio and video data streams coming to the SIP terminal are multiplexed into an H.324 multimedia data stream, which is subsequently sent to the H.324MS terminal.

When the conversation is over, in step 316, the H.324MS terminal and the MGC exchange H.245 CLC (Close Logic Channel) signalling messages to close the multimedia communication channel. The H.324MS terminal sends an H.245 ENDSession (End Session) signalling messages to request the MGC to close the H.245 call control channel in step 317. In step 318, the H.324MS terminal sends a REL (Release) message to the MGC to request the hang-up process for the call.

The MGC sends an SIP command, BYE, to SIP terminal in step 333 and the SIP terminal sends a response signal 200 to the MGC. in step 334 and the multimedia call is then ended.

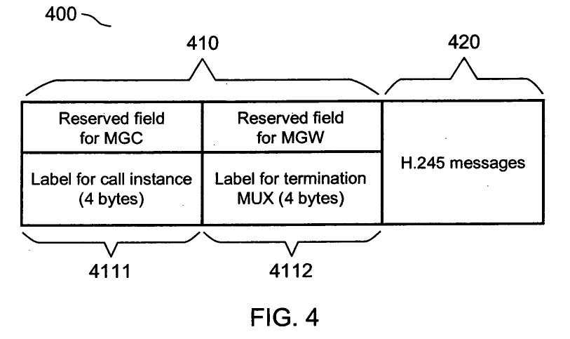

FIG. 4 is an example of an H.245 signalling message 400 with a Call Reference message head 410 added according to an embodiment of the present invention. The H.245 signalling message 400 has a base payload 420. The Call Reference message head 410 has at lease one of the two fields—the reserved field 4111 for MGC and the reserved field 4112 for MGW. The second field is optional.

The MGC sends the information about the added field to the MGW via an H.248 message. The command format of the Call Reference message head is negotiated or pre-configured between the MGW and the MGC so that they both can decode the added call reference message head 410 correctly.

The Call Reference message head 410 could have a fixed length or a variable length. As an example, the reserved field for MGC 4111 and the reserved field for MGW 4112 are both four bytes long. If it is of variable length, it could follow the TLV (Tag, length, value) format.

The specific content of a Call Reference message head 410 is also pre-determined by the MGW and the MGC. For example, the “call instance” field 4112 is used by the MGW for sending the H.245 signalling message 400 to the corresponding processing instance in the MGW. Based on the Call Reference message head 410, the MGW can send the H.245 signalling message 400 to a corresponding terminal.

The two reserved fields 4111 and 4112 in the Call Reference message 410 are used to instruct MGW and MGC how to forward the call setup messages. The MGC forwards the H.245 signalling message 400 to the corresponding call setup instance, based on the information in the reserved field 4111 for the MGC. Similarly, the MGW forwards the H.245 signalling message 400 to the corresponding terminal, based on the information in the reserved field 4112 for the MGW. The H.245 signalling message body field 420 is the actual H.245 signalling message exchanged between the MGC and the remote H.324 terminal.

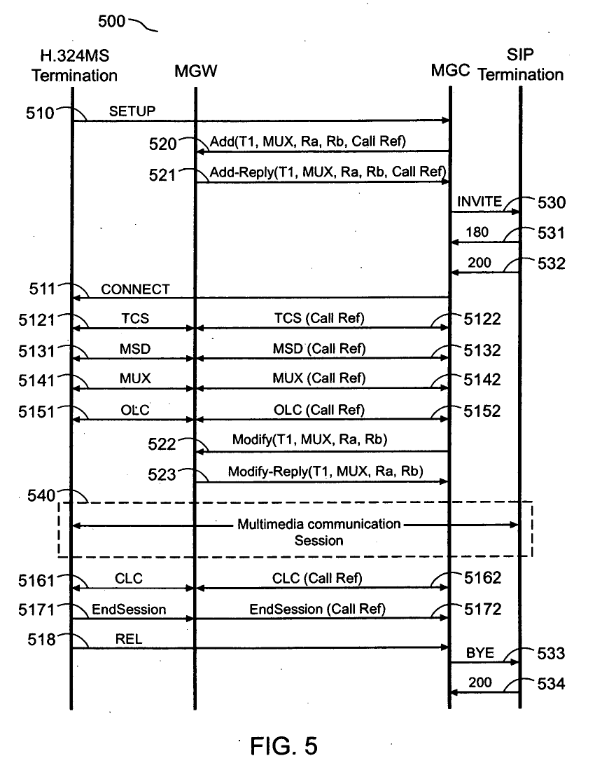

FIG. 5 shows a call setup process 500 between an H.324MS terminal and a SIP terminal according to one embodiment of the present invention. Similar to the call setup process 300 shown in FIG. 3, the call setup process 500 begins by a 3G mobile terminal (H.324MS) initiating a “call setup” process for a multimedia call through sending a SETUP message to an MGC (i.e., MSC server) in step 510. Based on the information in the SETUP message, the MGC acknowledges that the call is a multimedia call and the recipient of the call is an SIP terminal in the wired-line network. Using the standard H.248 protocol Add command, the MGC requests the MGW to allocate resources to four terminations: Ti, MUX, audio Ra and video Rb in step 520. The Add command carries the call setup parameters for all four terminations. Additionally, it also adds a field, called Call Ref, for the multimedia call setup. Using the H.248 Add-Reply command, the MGW returns the resources that are allocated to T1, MUX, audio and video terminations for this call to the MGC in step 521. The message sent by the H.248 Add-Reply command also contains the Call Ref field. The MGC sends an SIP INVITE message to the SIP terminal in step 530. The message carries the Session Description Protocol (SDP) attributes for audio and video data streams. The INVITE message also carries the information about the resources, allocated for this call, to the SIP terminal. In step 531, the SIP terminal obtains the information about the resources allocated for this call and returns the ring signal 180. In step 532, the SIP terminal returns the answer signal 200 to the MGC. In step 511, the MGC sends an CONNECT message back to the H.324MS terminal, which informs the H.324MS terminal that the call has been answered and the call setup initiation is completed.

Then following messages are exchanged between the H.324MS terminal and the MGW via the H.245 call control channel and between the MGW and the MGC via a signaling tunnel, which is constructed with the H.245 signalling messages: an H.245 call control signalling message, Terminal Capability Set (TCS) in step 5121 and 5122, an H.245 call control signalling message, master/slave determination (MSD) in steps 5131 and 5132, an H.245 call control signalling message, MUX, in step 5141 and 5142 and an H.245 call control signalling message, Open Local Channel (OLC), in step 5151 and 5152.

In step 522, the MGC sends an H.248 command Modify to the MGW. The command includes information about the multiplex table, audio, and video CODEC for this multimedia call. The MGW executes the command Modify and returns the outcome of the execution by sending a Modify-reply command back to the MGC in step 523. The call setup process is completed.

In step 540, the multimedia communication channel between the H.324MS terminal and SIP terminal is opened and both parties communicate with each other.

When the conversation is over, the following messages are exchanged between the H.324MS terminal and the MGW via the H.245 call control channel and between the MGW and the MGC via a signaling tunnel, which is constructed with the H.245 signalling messages: an H.245 call control signalling message, H.245 CLC (Close Logic Channel), to close the multimedia communication channel in step 5161 and 5162, an H.245 call control signalling message, ENDSession (End Session) message, to request the MGC to close the H.245 call control channel in step 5171 and 5172.

In step 518, the H.324MS terminal sends a REL (release) message to the MGC to request the hang-up process for the call. In step 533, the MGC sends an SIP command, BYE, to the SIP terminal. In step 534, The SIP terminal sends a response signal 200 to the MGC. The multimedia call is then ended.

All the H.245 signalling messages exchanged between the MGW and the MGC carry the extra call reference information, or Call Ref. Based on the Call Ref information, the MGC forwards the H.245 signalling messages to the corresponding multimedia call and the MGW forwards the H.245 signalling messages to the corresponding terminal.

Unlike the messages exchanged between the MGW and MGC, any H245 message exchanged between the MGW and the H324MS terminal does not contain a Call Reference message. One of the unique distinctions between this embodiment of the present invention and the existing protocol is that the call sequences in steps 5122, 5132, 5142, 5162 and 5172 contain an extra Call Ref field.

The MGC can send information about Call Reference messages to the MGW in the following two ways: (1) when the MGC sends the MGW an Add message to add a terminal; or (2) when the MGC sends a Modify command to the MGW after the terminal is setup. After the MGW receives the Call Reference information from the MGC, it will include the Call Reference message in the corresponding reserved MGC field in the H.245 signalling message that the MGW sends back to the MGC.

There are several ways that the MGW uses H.248 to obtain the information for the Call Reference message. For example, the MGW can reuse the H.248 event detection report function to retrieve the Request ID in termination MUX. When the MGW forwards the H.245 signalling message to the MGC, the request ID is used as the Call Reference message in the H.245 signalling message, i.e., the Request ID already contains a processing instance linked to the message.

One of the major advantages of this invention is to reduce the resource requirement for setting a SCTP/TCP/UDP tunnel for every multimedia call. The SCTP/TCP/UDP tunnel carries H.245 signalling messages between the MGW and the MGC with the MGC in charge of terminating H.245 call setup signalling messages.

In the previous section, one method is described to exchange H.245 signalling messages by establishing a tunnel, which may be a SCTP/TCP/UDP link between the MGW and the MGC in an H.324MS terminal and H.323/SIP terminal internetworking system. Since there is already an H.248 signaling link through which H.248 messages are exchanged between the MGW and the MGC, it is possible to piggyback the H.245 signalling messages in the H.248 messages and send them through the H.248 tunnel. The second method is described in the following sections.

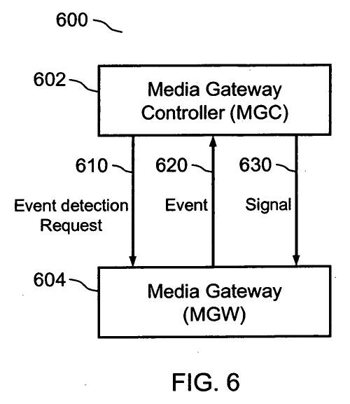

FIG. 6 is a diagram showing interactions 600 between a MGC 602 and a MGW 604 when they are exchanging H.245 signalling messages using an H.248 tunnel. The MGC 602 issues to the MGW 604 an “event detection” request 610 which directs the MGW 604 to report receiving any H.245 signalling message. When the MGW 604 detects an H.245 signalling message in the multimedia data stream from the H.324 terminal, it sends an H.248 Notify command to the MGC to report the detection of an event. The H.245 signalling message is sent to the MGC 602 as the parameter of the event 620 in the H.248 command.

When the MGC 602 sends an H.245 signalling message to a remote H.324 terminal, it signals the MGW 604 about the H.245 signalling message event by sending H.248 commands such as Add, Modify, Move and etc. to the MGW 604. The H.245 signalling message is sent as the parameter of the signal 630 in the H.248 command. When the MGW 604 receives the signal, it retrieves the H.245 signalling message and multiplexes the H.245 signalling message with audio and video data streams into an H.324 multimedia data stream and sends it to the H.324 terminal.

In order to embed an H.245 signalling message in an H.248 message, a set of corresponding events and signals must be defined. For example, an h245 msg event defined in the h245 package can be used as an event in the H.248 message sent from the MGW 604 to the MGC 602. This event indicates that an H.245 signalling message is embedded as the parameter of the event in the H.248 message. Using the H.248 tunnel to exchange H.245 signalling messages between the MGW 604 and the MGC 602 has several advantages.

This method takes advantage of all the facilities provided by the H.248 protocol. If an H.248 message exchanged between a MGW and a MGC is based on the reliable transport layer protocol, such as SCTP and TCP, then the H.245 signalling message, embedded in the H.248 message, inherits the reliable service from the H.248 protocol.

If the transport layer for the H.248 message is based on the unreliable protocol, such as UDP, the H.248 protocol provides its own reliability mechanism. The re-transmission service is provided in the H.248 protocol layer. If the timer expires before the sender of the H.248 message receives the response from its peer, the H.248 protocol layer will re-transmit the message without the upper layer's intervention. Because of this feature in the H.248 protocol, the H.245 signalling message also inherits the reliable transmission service from the H.248 protocol.

In addition, there is no need to establish a specific communication channel between a MGW and a MGC to exchange H.245 signalling messages. The H.245 signalling message sent to the MGC is embedded as the parameter of the event in the H.248 message. The Request ID of the event in the H.248 message is assigned by the MGC. The Request ID includes a label for a service instance, so that the H.245 signalling message does not have to carry the call reference message head.

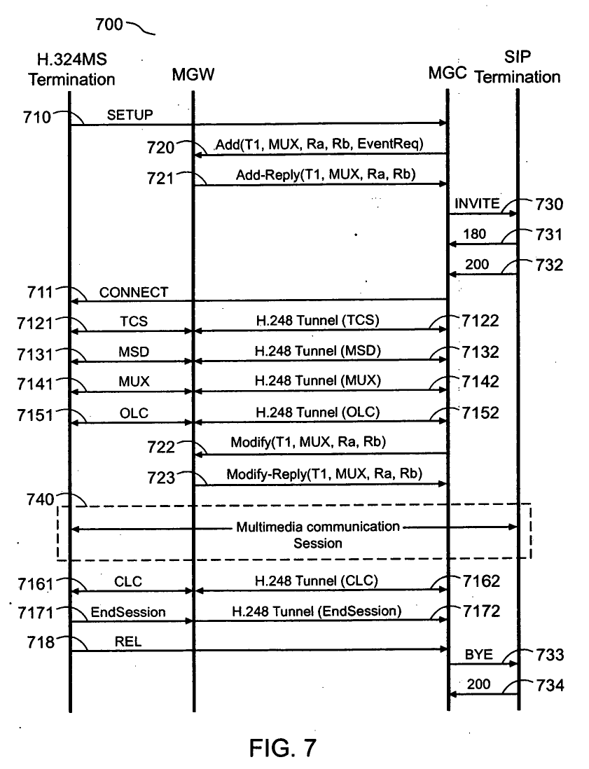

FIG. 7 shows another call setup process 700 using an H.248 tunnel to exchange H.245 signalling messages between a MGW and a MGC according to another embodiment of the present invention. Again, it is based on the example shown in FIG. 3, and the H.324MS terminal and H.323/SIP terminal internetworking system uses the MGC in charge of terminating the H.245 call setup signalling messages. The differences between this invention and the existing protocol are identified in FIG. 7. This embodiment also begins with a 3G mobile terminal (H.324MS) initiating a “call setup” process for a multimedia call through sending a SETUP message to an MGC (i.e., MSC server) in step 710. Based on the information in the SETUP message, the MGC acknowledges that the call is a multimedia call and the recipient of the call is an SIP terminal in the wired-line network. Using the standard H.248 protocol Add command, the MGC requests the MGW to allocate resources to four terminations: T1, MUX, audio Ra and video Rb in step 720. The Add command carries the call setup parameters for all four terminations, and also includes an “event detection” request that directs the Media Gateway (MG) to detect an H.245 signalling message event (EventReq). Using the H.248 Add-Reply command, the MGW returns the resources, which are allocated to T1, MUX, audio and video terminations for this call to the MGC in step 721. The MGC sends an SIP INVITE message to the SIP terminal in step 730. The message carries the Session Description Protocol (SDP) attributes for audio and video data streams. The INVITE message also carries the information about the resources, allocated for this call, to the SIP terminal. In step 731, the SIP terminal obtains the information about the resources allocated for this call and returns the ring signal 180. In step 732, the SIP terminal returns the answer signal 200 to the MGC. In step 711, the MGC sends a CONNECT message back to H.324MS terminal, which informs the H.324MS terminal that the call has been answered and the call setup initiation is completed.

Then following messages are exchanged between the H.324MS terminal and the MGW via the H.245 call control channel and between the MGW and the MGC via an H.248 tunnel: an H.245 call control signalling message, Terminal Capability Set (TCS), in step 7121 and 7122, an H.245 call control signalling message, master/slave determination (MSD), in steps 7131 and 7132, an H.245 call control signalling message, MUX, in steps 7141 and 7142 and an H.245 call control signalling message, Open Local Channel (OLC), in steps 7151 and 7152.

In step 722, the MGC sends an H.248 command Modify to the MGW. The command includes information about the multiplex table, audio, and video CODEC for this multimedia call. The MGW executes the command Modify and returns the outcome of the execution by sending a Modify-reply command back to the MGC in step 723. Then the call setup process is completed.

In step 740, the multimedia communication channel between the H.324MS terminal and SIP terminal is opened and both parties communicate with each other.

In the aforementioned sequences, from steps 7122 through 7172, the H.245 signalling message sent from the MGW to the MGC is embedded as the parameter of an event in the H.248 Notify command. The H.245 signalling message sent from the MGC to the MGW is embedded either as the parameter of a signal or as the value of an attribute of the termination in the H.248 Modify message.

When the conversation is over, the following messages are exchanged between the H.324MS terminal and the MGW via the H.245 call control channel and between the MGW and the MGC via an H.248 tunnel: an H.245 call control signalling message, H.245 CLC (Close Logic Channel), to close the multimedia communication channel in steps 7161 and 7162, an H.245 call control signalling message, ENDSession (End Session) message, to request the MGC to close the H.245 call control channel in steps 7171 and 7172.

In step 718, the H.324MS terminal sends an REL (release) message to the MGC to request the hang-up process for the call. In step 733, the MGC sends an SIP command, BYE, to SIP terminal. In step 734, The SIP terminal sends a response signal 200 to the MGC. The multimedia call is then ended.

The event in the H.248 command sent by the MGW carries a Request ID, which includes a label for the call instance. Because the Request ID is assigned by the MGC, the MGC can deliver the H.245 signalling message, embedded as the parameter of the event, to a corresponding call instance.

When sending a signal or an attribute of a termination to the MGW in the H.248 command, the MGC specifies the label of termination MUX, which can be used by the MGW to associate the H.245 signalling message to its corresponding terminal.

The H.248 tunnel only exists between the MGW and the MGC. There is no H.248 tunnel between the MGW and the H324MS terminal. A unique distinction between this invention and the existing protocol is that the call sequence numbers 7122˜7152 and 7162˜7172 are divided into two parts. All the messages exchanged between the MGW and H.324MS terminal are the H.245 signalling messages. All the H.245 signalling messages exchanged between the MGW and the MGC are the H.245 signalling messages transmitted via an H.248 tunnel.

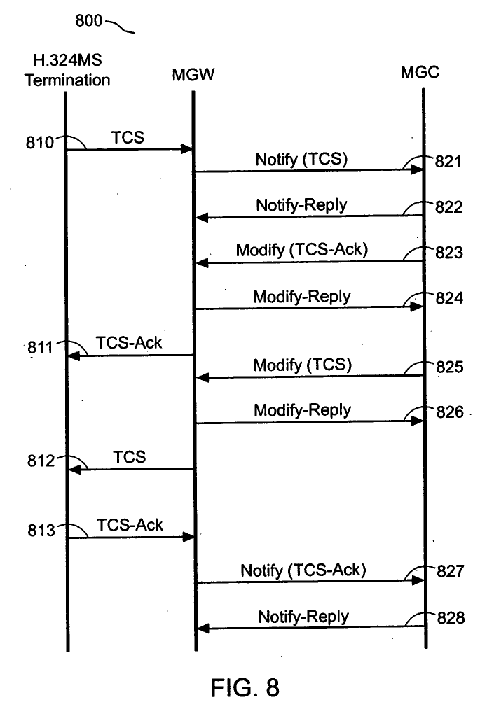

FIG. 8 is a summary of a series of operations 800 inside an H.248 tunnel shown in FIG. 7. The operations 800 show how one H.245 signalling message, the TCS (terminal capability set), maps to the call sequence with the H.248 commands exchanged between the H.324 MS, MGW and MGC. The sequence involves H.248 commands such as Notify, Modify, etc.

In step 810, TCS (terminal capability set) issued by the H.324MS terminal is sent to the MGW via the H.245 call control channel in the H.324 multimedia data stream.

Then following messages are exchanged between the MGW and the MGC via an H.248 tunnel: an H.248 command, Notify, in step 821 wherein Notify command, which is issued by the MG, includes an H.245 signalling message as the parameter of an event. An H.248 command, Notify-Reply, in step 822 wherein the MGC confirms that it receives the Notify command from the MGW.

Then following messages are exchanged between the MGW and the MGC via an H.248 tunnel: an H.248 command, Modify, in step 823 wherein the Modify command, which is issued by the MGC, carries TCS-Ack as the parameter of a signal in the H.248 command. An H.248 command, Modify-Reply, in step 824 wherein the MGW confirms that it receives the Modify command from the MGC.

In step 811, the MGW sends a TCS-Ack to the H.324 MS via the H.245 signalling message control channel in the H.324 multimedia data stream.

Then, following messages are exchanged between the MGW and the MGC via an H.248 tunnel: an H.248 command, Modify, in step 825 wherein the Modify command, which is issued by the MGC to set up the capability set of a local termination, carries TCS as the parameter of a signal in the H.248 command. An H.248 command, Modify-Reply, in step 826 wherein the MGW confirms that it receives the Modify command from the MGC.

In step 812, the MGW sends a TCS to the MS via the H.245 signalling message control channel in the H.324 multimedia data stream. In step 813, the H.324 MS sends a TCS-Ack to the MGW via the H.245 signalling message control channel in the H.324 multimedia data stream. In step 827, the MGW sends an H.248 Notify command to the MGC. The Notify command includes a TCS-Ack as the parameter of an event. In step 828, the MGC confirms that it receives the Notify command from the MGW.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for setting up a multimedia session having a gateway module and a gateway controller module, the method comprising:
receiving a call setup message by the gateway controller module from a first terminal for setting up the multimedia session with a second terminal;
exchanging at least one call reference between the gateway controller module and gateway module based on the call setup message for identifying the multimedia session;
exchanging one or more session setup messages through a communication tunnel between the gateway module and gateway controller module for allocating resources for the multimedia session with the call reference including a predetermined location within the session setup messages for containing session information; and
initiating the multimedia session between the first and second terminals with the allocated resources.

2. The method of claim 1, wherein the exchanging of at least one call reference further includes providing the call reference by the gateway controller module.

3. The method of claim 2, wherein the call reference includes a label for call instance for identifying the first terminal by the gateway controller module.

4. The method of claim 2, wherein the call reference further includes a first predetermined location for containing predetermined session information provided by the gateway module.

5. The method of claim 4, wherein the call reference further includes a second predetermined location for containing predetermined session information provided by the gateway controller module.

6. The method of claim 2, wherein the call reference includes a label for termination MUX for identifying the first terminal by the gateway module.

7. The method of claim 2, wherein exchanging the session setup messages further includes adding the call reference to one or more H.245 signalling messages sent from the first terminal to the gateway controller module through the gateway module by the gateway module.

8. The method of claim 2, wherein exchanging the session setup messages further includes stripping the call reference from one or more H.245 signalling messages sent from the gateway controller module to the first terminal through the gateway module by the gateway module.

9. A method for setting up a multimedia session having a gateway module and a gateway controller module, the method comprising:
receiving a call setup message by the gateway controller module from a first terminal for setting up a multimedia session with a second terminal;
instructing the gateway module for notifying the gateway controller module for a first predetermined type of one or more session setup messages destined for the gateway controller module for the multimedia session;
exchanging the session setup messages between the gateway controller module and the gateway module by embedding the session setup messages of the first predetermined type in a session setup message of a second predetermined type through a communication tunnel between the gateway module and gateway controller module for allocating resources for the multimedia session; and
initiating the multimedia session between the first and second terminals with the allocated resources.

10. The method of claim 9, wherein instructing further includes instructing the gateway module to flag the session setup message of the first predetermined type as an event in the session setup message of the second predetermined type.

11. The method of claim 9, wherein exchanging further includes detecting the event by the gateway controller module.

12. The method of claim 9, wherein instructing further includes instructing the gateway module to detect the session setup message of the first predetermined type when there is a signal in the session setup message of the second predetermined type sent by the gateway controller module.

13. The method of claim 9, wherein the first predetermined type of the session setup messages are of H.245 type.

14. The method of claim 9, wherein the second predetermined type of the session setup messages are of H.248 type.

15. A gateway controller module configured for receiving a call setup message from a first terminal for setting up a multimedia session with a second terminal, and communicating with a gateway module through a communication tunnel by exchanging one or more session setup messages for allocating resources for the multimedia session, wherein the communication tunnel defines a predetermined location within the session setup messages.

16. The system of claim 15, wherein the session setup messages are H.245 signalling messages.

17. The system of claim 15, wherein the gateway module adds the call reference to one or more H.245 signalling messages sent from the first terminal to the gateway controller module through the gateway module and strips the call reference from one or more H.245 signalling messages sent from the gateway controller module to the first terminal.

18. The system of claim 15, wherein the call reference includes a label for call instance for identifying the first terminal by the gateway controller module.

19. The system of claim 15, wherein the call reference includes a label for termination MUX for identifying the first terminal by the gateway module.

20. A gateway controller module configured for receiving a call setup message from a first terminal for setting up a multimedia session with a second terminal, and communicating with a gateway module through a communication tunnel by exchanging one or more session setup messages for allocating resources for the multimedia session, wherein session setup messages of a first predetermined type is embedded in a session setup message of a second predetermined type through a communication tunnel between the gateway module and gateway controller module.

21. The system of claim 20, wherein the first predetermined type of the session setup messages are of H.245 type.

22. The system of claim 20, wherein the second predetermined type of the session setup messages are of H.248 type.

23. The system of claim 20, wherein the gateway controller module instructs the gateway module to notify the gateway controller module for a first predetermined type of one or more session setup messages destined for the gateway controller module for the multimedia session.

24. The system of claim 23, wherein the gateway controller module further instructs the gateway module to flag the session setup message of the first predetermined type as an event in the session setup message of the second predetermined type.

25. The system of claim 23, wherein the gateway controller module further instructs the gateway module to detect the session setup message of the first predetermined type when there is a signal in the session setup message of the second predetermined type sent by the gateway controller module.
